(19) United States
(12) Patent Application Publication
(10) Pub. No.: US 2004/0051430 A1
(43) Pub. Date: Mar. 18, 2004

(54) Electromagnetic wave marker and electromagnetic wave marker system

(76) Inventors: Satoru Handa, Nara (JP); Keiji Yasui, Hyogo (JP); Koichi Nomura, Osaka (JP); Yoshihiko Tanji, Osaka (JP)

Correspondence Address: RATNERPRESTIA, P O BOX 980, VALLEY FORGE, PA, 19482-0980, US

(21) Appl. No.: 10/433,993

(22) PCT Filed: Sep. 25, 2002
(86) PCT No.: PCT/JP02/09883

(30) Foreign Application Priority Data
Sep. 26, 2001 (JP) 2001-293786

(51) Int. Cl. H01K 1/30

(52) U.S. Cl. 313/113

(57) ABSTRACT

An electromagnetic-wave marker includes a bar-like receiving antenna for receiving an electromagnetic wave, a frequency converting circuit coupled to the receiving antenna and for multiplying a frequency of the electromagnetic wave, a disc-like transmitting antenna for transmitting an electromagnetic wave of which frequency is multiplied by the frequency converting circuit, a nonmagnetic container for accommodating and placing the receiving antenna and the transmitting antenna such that the received electromagnetic wave and the transmitting electromagnetic wave intersect with each other at right angles, and an electromagnetic-wave reflector placed at a lower portion of the nonmagnetic container and for reflecting the electromagnetic wave along the transmitted direction. The marker is improved its anti-corrosion property, and at the same time, reduces its thickness, so that the marker can be laid down in various structures of roads such as an iron bridge.

### TECHNICAL FIELD

The present invention relates to an electromagnetic wave marker system that provides machine tools with services such as surveillance, guidance of the work and danger-prevention, or is used in a traffic system in which unmanned vehicles are operated as well as used in mobile units. The present invention also relates to an electromagnetic wave marker to be used in the foregoing system.

### BACKGROUND ART

An electromagnetic wave marker system and an electromagnetic wave marker are known, in general, as providing the following services: The system serves danger-prevention, and in a traffic system where unmanned vehicles are operated, the marker laid on a road radiates an electromagnetic wave of which peak comes just above the marker. On the other hand, a marker detector mounted to a vehicle detects an intensity distribution of the electromagnetic wave radiated, thereby detecting a travelling position of the vehicle in a lateral direction within a lane.

A conventional lane-marker using the electromagnetic wave is formed of a battery power source, a power supplying circuit, an antenna and a control circuit, and laid down in a paved portion of a road. An electromagnetic wave marker is equipped with a receiving antenna, a frequency converter for efficiently doubling a frequency of a received electromagnetic wave, and a transmitting antenna. This marker receives a weak electromagnetic wave transmitted from a marker detector, and reflectively transmits an electromagnetic wave having a different frequency from the received one with little loss, so that the marker does not need a battery power source or a power supplying circuit. As a result, a multiplying and reflective electromagnetic-wave marker system that achieves a high detection accuracy is available.

The foregoing electromagnetic-wave lane-marker is required to work properly in various structures of roads, such as in a land elevated portion of a road, an iron bridge made from steel, an overhead bridge made from concrete. Therefore, the conventional multiplying and reflective electromagnetic-wave marker discussed above integrates a ferrite sheet and a steel plate at its lower section in order to work properly in the foregoing structures.

In general, a thinner pavement is desirable for the iron bridge and the overhead bridge for reducing the dead weight, so that the lane-markers laid down in the pavement are desirably thinner. Since the lane-markers are laid down during the pavement work, they must be highly resistant to corrosion.

Indeed the conventional multiplying and reflective electromagnetic-wave marker can be used in various structures of the road, however, the ferrite sheet and steel plate prepared to the lower section of the marker increase a thickness of the marker per se. A naked steel plate is vulnerable to corrosion, so that it must be isolated from the open air, e.g., it should be sealed with a resin case or coated with glass. This isolation adds a further thickness, and also increases the cost.

### DISCLOSURE OF THE INVENTION

The electromotive wave marker of the present invention includes a transmitting antenna for transmitting an electromagnetic wave, a nonmagnetic container for accommodating the transmitting antenna, and an electromagnetic-wave reflector, which is disposed in the nonmagnetic container, for reflecting the electromagnetic wave along the transmitted direction.

### BRIEF DESCRIPTION OF THE DRAWINGS

FIG. 1 shows a perspective view of an electromagnetic wave marker in accordance with a first exemplary embodiment and a fourth through a sixth exemplary embodiments of the present invention.

FIG. 2 shows a perspective view of an electromagnetic wave marker in accordance with a second exemplary embodiment and the fourth through the sixth exemplary embodiments of the present invention.

FIG. 3 shows a perspective view of an electromagnetic wave marker in accordance with a third exemplary embodiment and the fourth through the sixth exemplary embodiments of the present invention.

FIG. 4 shows a structure of an electromagnetic wave marker-system in accordance with a seventh exemplary embodiment of the present invention.

FIG. 5 shows a structure of an electromagnetic wave marker-system in accordance with an eighth exemplary embodiment of the present invention.

FIG. 6 shows a perspective view of an electromagnetic wave marker-system applicable to a mobile unit in accordance with a ninth and a tenth exemplary embodiments of the present invention.

FIG. 7 shows a structure of an electromagnetic wave marker-system in accordance with an 11th and a 12th exemplary embodiments of the present invention.

FIG. 8 shows a relation of a receiving antenna of a marker detector with respect to an intensity distribution image of the electromagnetic wave reflectively transmitted in the marker system in accordance with the 11th exemplary embodiment.

FIG. 9 shows a block diagram illustrating a structure of an electromagnetic wave marker-system in accordance with a 13th exemplary embodiment of the present invention.

### PREFERRED EMBODIMENTS OF THE INVENTION

Exemplary embodiments of the electromagnetic wave marker and the electromagnetic wave marker-system of the present invention are demonstrated hereinafter with reference to the accompanying drawings. The present invention is applicable to surveillance and guidance of the work of machine tools, guidance of a robotized cleaner, and a traffic system. The embodiments refer to the traffic system as an example.

Exemplary Embodiment 1

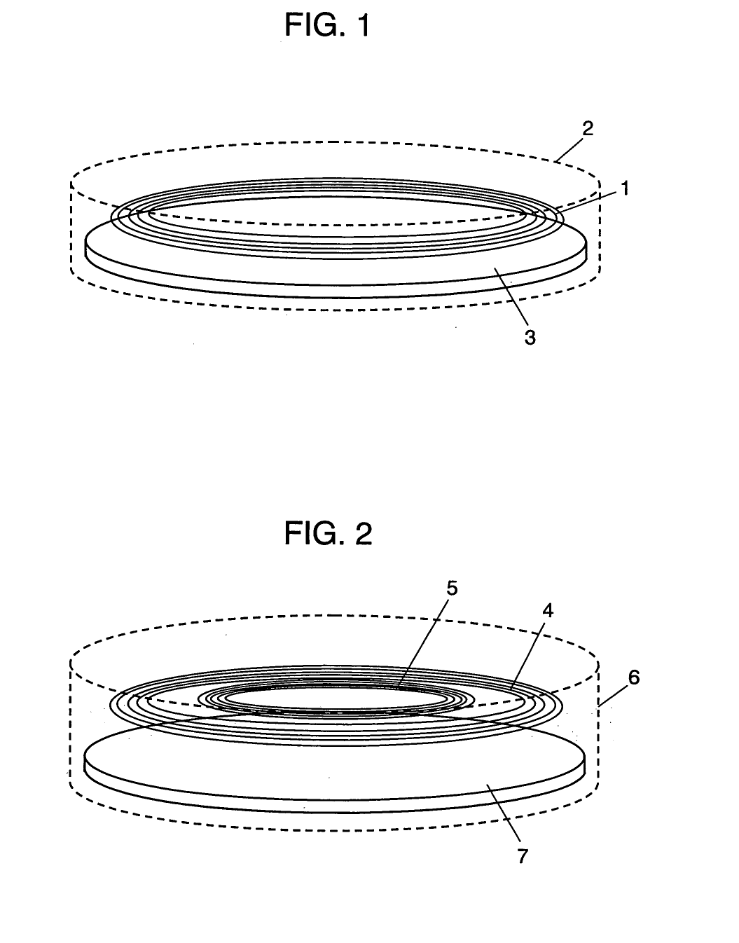

FIG. 1 shows a perspective view illustrating a structure of an electromagnetic wave marker in accordance with the first exemplary embodiment of the present invention. An electromagnetic wave marker is laid down as a lane marker in a road, and receives an electromagnetic wave transmitted from a mobile unit (not shown) such as a car running on the road. The electromagnetic wave is transmitted for e.g., identifying a position of the car. The lane marker receives and resonates with the wave before transmitting an electromagnetic wave. The marker includes transmitting antenna 1 which serves also as a receiving antenna, electromagnetic-wave reflector 3 for reflecting the electromagnetic wave transmitted from antenna 1 along the transmitted direction, and nonmagnetic container 2 which is split into two parts, i.e., a lid case and the other case. Antenna 1 is placed in the lid case, and reflector 3 is placed in the other case, then the two cases are joined to form container 2.

Transmitting antenna 1 radiates the electromagnetic wave outward, and is shaped like a flat circle, oval, rectangle or polygon. In this first embodiment, antenna 1 is shaped like a looped circle. Nonmagnetic container 2 is made of nonmagnetic material and shaped like a disc of which upper section accommodates antenna 1. Reflector 3 reflects the electromagnetic wave radiated downward, out of the entire radiated wave, upward of the transmitting direction. Reflector 3 is thus shaped in a larger disc than antenna 1, and is placed in container 2 at a lower portion under antenna 1 in parallel with and opposite to antenna 1.

In this embodiment, reflector 3 is placed in the lower portion of container 2 such that reflector 3 is under, in parallel with and opposite to antenna 1. Therefore, an electromagnetic-wave closed circuit that does not absorb an electromagnetic wave can be formed without being influenced by a structure of a lower part of antenna 1, i.e., the structure on a side on which the marker is placed. As a result, a ferrite sheet and a steel plate, which are used in the conventional markers, are not needed. Thus the thickness becomes thinner than a conventional one, and the marker in accordance with the first embodiment can be laid down with ease in iron bridges or overhead bridges, of which pavements are desirably thinner. The markers are simplified in structure, they can be thus manufactured at a lower cost.

In the case when a lane marker is laid down on a steel plate such as an iron bridge, the electromagnetic wave can be absorbed, in general, by a structure underneath the lane marker, such as the steel plate, and an electromagnetic-wave close circuit is prevented from being formed. As a result, the transmitting antenna possibly cannot supply an adequate output. When the marker is laid down in a road formed of reinforced concrete including iron bars, the iron bars can diffract the electromagnetic wave, thereby producing irregular intensity in the reflected electromagnetic-wave.

The marker in accordance with the first embodiment; however, makes reflector 3 reflect the wave along the transmitted direction, and reflector 3 is placed under, opposite to and in parallel with transmitting antenna 1. This structure allows a downward output from antenna 1 to be reflected upward for forming the electromagnetic-wave closed circuit, so that an efficient transmission is achieved. The wave diffraction due to the iron bars can be prevented by reflector 3, thereby producing the stable reflected electromagnetic wave.

Reflector 3 is enclosed in container 2 in this embodiment; however, it can be attached to an outer bottom face of container 2 or laid down in the bottom of container 2 with the same advantage as discussed above. A loop antenna is used as transmitting antenna 1 and a cylindrical nonmagnetic container 1 is used in this embodiment; however, they are not limited to those shapes, and the same advantage as discussed above can be expected with different shapes.

Exemplary Embodiment 2

FIG. 2 shows a perspective view illustrating a structure of an electromagnetic wave marker in accordance with the second exemplary embodiment of the present invention. The second embodiment differs from the first one in the following point: an electromagnetic-wave marker is equipped with a transmitting antenna and a receiving antenna independently in addition to an electromagnetic-wave reflector. This difference is mainly described hereinafter.

The electromagnetic-wave marker comprises the following elements:

receiving antenna 4 for receiving an electromagnetic wave of a specific frequency sent from a transmitting antenna (not shown) of a marker detector (not shown) mounted to a mobile unit such as a car;

transmitting antenna 5 for transmitting an electromagnetic wave of a specific frequency based on the electromagnetic wave received by receiving antenna 4;

electromagnetic-wave reflector 7; and

nonmagnetic container 6 accommodating antenna 5 and reflector 7.

Receiving antenna 4 is shaped like a flat loop for receiving the external electromagnetic wave. Transmitting antenna 5 is shaped like a flat loop for radiating the electromagnetic wave outward.

Nonmagnetic container 6 is made of nonmagnetic material and shaped like a disc. Container 6 accommodates antenna 4 and antenna 5 that is placed within and flush with antenna 4 in an upper portion. Reflector 7 reflects upward the electromagnetic wave radiated downward out of the radiated wave from antenna 5 in order to reflect the electromagnetic wave along the transmitted direction. Reflector 7 is thus shaped like a disc larger than antennas 4, 5 and placed under, opposite to and in parallel with antennas 4, 5. Reflector 7 is placed in container 6 at a lower portion.

The second embodiment expects a similar advantage to that of the first embodiment. To be more specific, reflector 7 is placed in container 6 at the lower portion, and also under antennas 4, 5 such that reflector 7 faces the antennas and is positioned in parallel with the antennas. Thus an electromagnetic wave closed circuit, which does not absorb the electromagnetic wave, can be formed without being influenced by a structure of a lower side of both the antennas, i.e., the side on which the electromagnetic-wave marker is to be laid down. As a result, a ferrite sheet and a steel plate, which are used in the conventional markers, are not needed. Thus the thickness becomes thinner than a conventional one, and the marker in accordance with the second embodiment can be laid down with ease in every possible structure of roads. The markers are simplified in structure, so that they can be manufactured at a lower cost.

The marker in accordance with the second embodiment allows a downward output from transmitting antenna 5 to be reflected upward for forming the electromagnetic-wave closed circuit, so that an efficient transmission is achieved. The wave diffraction due to the iron bars can be prevented by reflector 7, thereby producing a stable reflected electromagnetic wave.

Reflector 7 is enclosed in container 6 in this embodiment; however, it can be attached to an outer bottom face of container 6 or laid down in the bottom of container 6 with the same advantage as discussed above. A loop antenna is used as both of receiving antenna 4 and transmitting antenna 5, and a cylindrical nonmagnetic container 6 is used in this embodiment; however, they are not limited to those shapes, and the same advantage as discussed above can be expected with different shapes.

Exemplary Embodiment 3

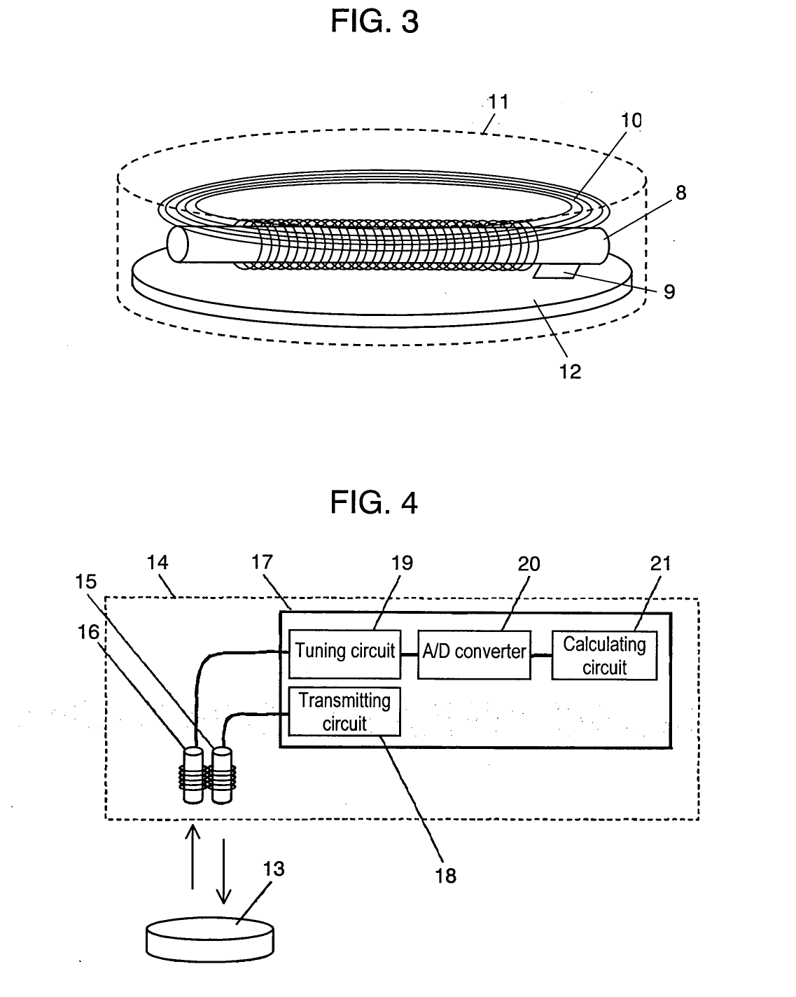

FIG. 3 shows a perspective view illustrating a structure of an electromagnetic wave marker in accordance with the third exemplary embodiment of the present invention. This third embodiment differs from the first one in the following point: The electromagnetic-wave marker in accordance with the third embodiment is equipped with an electromagnetic-wave reflector, a transmitting antenna and a rod-shaped receiving antenna made of ferrite. Both the antennas are placed such that the electromagnetic-wave to be transmitted and the electromagnetic-wave to be received intersect with each other at right angles. The following description focuses mainly on this difference.

Receiving antenna 8 is shaped like a bar and formed of a bar antenna which is made by winding coils on a rod ferrite. Antenna 8 receives an electromagnetic wave of a first frequency supplied from the transmitting antenna (not shown) of a marker detector (not shown) mounted in a vehicle. Frequency converter 9 converts the frequency of the electromagnetic wave received by the antenna 8 to generate a second clock frequency that is twice as much as the first frequency.

Transmitting antenna 10 radiates outward the electromagnetic wave, and is shaped like a flat circle, oval, rectangle or polygon. In this third embodiment, antenna 10 is shaped like a flat looped circle. Antenna 10 outputs a second clock frequency generated by frequency converter 9 as an electromagnetic wave. Antenna 10 is placed under, in parallel with and opposite to receiving antenna 8 such that the electromagnetic-wave to be transmitted and the electromagnetic-wave to be received intersect with each other at right angles.

Nonmagnetic container 11 is made of nonmagnetic material and shaped like, a circle, oval, rectangular, or a polygon. In this embodiment container 6 is shaped like a disc. Container 11 accommodates antenna 8 and antenna 10 at its upper portion.

Electromagnetic-wave reflector 12 reflects the electromagnetic wave along the transmitted direction, and reflects upward the electromagnetic wave radiated downward out of the entire radiated wave from antenna 10. Reflector 12 is thus shaped like a disc larger than antennas 8, 10 and placed under, opposite to and in parallel with antennas 8, 10. Container 11 accommodates reflector 12 at its lower portion.

In the third embodiment, receiving antenna 8 receives the electromagnetic wave sent from the marker detector, and frequency converter 9 doubles this wave. Transmitting antenna 10 thus can transmit an electromagnetic wave of a different frequency such that the wave intersects the magnetic field of the received electromagnetic-wave at right angles. As a result, the marker detector can detect the marker with a weak transmitting output, and does not need to separate its own transmitted component from the received electromagnetic wave for detecting the marker.

The third embodiment expects a similar advantage to that of the first embodiment. To be mores specific, reflector 12 is placed in container 11 at the lower portion of container 11, and under antennas 8, 10 such that reflector 12 faces the antennas and is positioned in parallel with the antennas. Thus an electromagnetic-wave closed circuit, which does not absorb the electromagnetic wave, can be formed without being influenced by a structure of a lower side of both the antennas, i.e., the side with which the electromagnetic-wave marker is to be laid down in a road. As a result, a ferrite sheet and a steel plate, which are used in the conventional markers, are not needed. Thus the thickness becomes thinner than a conventional one, and the marker in accordance with the third embodiment can be laid down with ease in every possible structure of roads. The markers are simplified in structure, so that they can be manufactured at a lower cost.

The marker in accordance with the third embodiment allows a downward output from transmitting antenna 10 to be reflected upward for forming the electromagnetic-wave closed circuit, so that an efficient transmission is achieved. The wave diffraction due to the iron bars can be prevented by reflector 12, so that a stable reflected electromagnetic wave can be produced.

Reflector 12 is enclosed in container 11 in this embodiment; however, it can be attached to an outer bottom face of container 11 or laid down in the bottom of container 11 with the same advantage as discussed above. A loop antenna is used as both of receiving antenna 8 and transmitting antenna 10, and a cylindrical nonmagnetic container 11 is used in this embodiment; however, they are not limited to those shapes, and the same advantage as discussed above can be expected with different shapes.

Exemplary Embodiment 4

An electromagnetic-wave marker in accordance with the fourth exemplary embodiment has an electromagnetic-wave reflector made of nonferrous metal that replaces those reflectors of the markers in accordance with the first through third embodiments shown in FIG. 1 through FIG. 3. The electromagnetic-wave marker in accordance with this fourth exemplary embodiment is thus described with reference to FIG. 1 through FIG. 3. Reflectors 3, 7, 12 are made of nonferrous metal and reflect the electromagnetic wave along the transmitted direction.

In the fourth embodiment, reflector 3, 7, 12 are made of nonferrous metal plate, so that electromagnetic reflecting effect is obtainable with a single material. Since the nonferrous metal plate is made of a single material, the marker can be further thinned, and the simple structure can reduce the number of assembling steps as well as the cost.

Reflector 3, 7, 12 made of nonferrous metal, not to mention, produce similar advantages to those of the markers described in the first through third embodiments. To be more specific, they can reduce the thickness of the marker and increase the transmitting efficiency of the transmitting antenna, and also prevent the electromagnetic-wave diffraction due to the iron bars.

Exemplary Embodiment 5

An electromagnetic-wave marker in accordance with the fifth exemplary embodiment has an electromagnetic-wave reflector made from stainless steel that replaces those reflectors of the markers in accordance with the first through third embodiments shown in FIG. 1 through FIG. 3. The electromagnetic-wave marker in accordance with this fifth exemplary embodiment is thus described with reference to FIG. 1 through FIG. 3. Reflectors 3, 7, 12 are made from stainless steel and reflect the electromagnetic wave along the transmitted direction.

In the fifth embodiment, reflector 3, 7, 12 are made from stainless steel, namely, a single material. Since the stainless steel is rustproof material, the marker does not need to be encapsulated with resin as the conventional one is, so that the marker can be further thinned. The reflector can be built by just mounting a simple plate, and the simple structure can reduce the number of assembling steps and the material cost, so that the cost reduction is achievable.

Reflector 3, 7, 12 made of stainless steel, not to mention, produce similar advantages to those of the markers described in the first through third embodiments. To be more specific, they can reduce the thickness of the marker and increase the transmitting efficiency of the transmitting antenna, and also prevent the electromagnetic-wave diffraction due to the iron bars.

Exemplary Embodiment 6

An electromagnetic-wave marker in accordance with the sixth exemplary embodiment has an electromagnetic-wave reflector made from aluminum plate that replaces those reflectors of the markers in accordance with the first through third embodiments shown in FIG. 1 through FIG. 3. The electromagnetic-wave marker in accordance with this sixth exemplary embodiment is thus described with reference to FIG. 1 through FIG. 3. Reflectors 3, 7, 12 are made from aluminum plate and reflect the electromagnetic wave along the transmitted direction.

In the sixth embodiment, reflector 3, 7, 12 are made from aluminum plate, namely, a single material. Since the aluminum plate is rustproof and anti chemical-corrosion material, the marker does not need to be encapsulated with resin as the conventional one is, so that the marker can be further thinned. The reflector can be built by just mounting a simple plate, and the simple structure can reduce the number of assembling steps and the material cost, so that the cost reduction is achievable. Further since the aluminum has a low specific gravity, the weight of the marker can be reduced.

Reflector 3, 7, 12 made of aluminum plate, not to mention, produce similar advantages to those of the markers described in the first through third embodiments. To be more specific, they can reduce the thickness of the marker and increase the transmitting efficiency of the transmitting antenna, and also prevent the electromagnetic-wave diffraction due to the iron bars.

Exemplary Embodiment 7

FIG. 4 shows a structure of an electromagnetic wave marker system in accordance with the seventh exemplary embodiment of the present invention. Reflective electromagnetic-wave marker 13 is laid down in a road, and the marker described in any one of embodiments 1 through 6 shown in FIGS. 1-3 is used here. Marker detector 14 is mounted to a mobile unit such as a vehicle. Transmitting antenna 15 prepared to detector 14 transmits an electromagnetic wave of a specific frequency to reflective electromagnetic-wave wave marker 13. In FIG. 4, antenna 15 is formed of a bar antenna made by winding a coil on a ferrite bar; however, it is not limited to this form.

Receiving antenna 16 prepared to marker detector 14 receives the electromagnetic wave of a specific frequency reflected from reflective marker 13. In this embodiment, antenna 16 is formed of a bar antenna made by winding a coil on a ferrite bar; however, it is not limited to this form.

Detecting section 17 prepared to marker detector 14 comprises the following elements:

transmitting circuit 18;

tuning circuit 19;

analog/digital converter 20 (A/D converter); and

calculating circuit 21.

Transmitting circuit 18 is coupled to transmitting antenna 15 and outputs a specific signal to antenna 15. Tuning circuit 19 is coupled to receiving antenna 16 and tunes the received electromagnetic wave to a specific frequency for extracting the tuned frequency. A/D converter 20 is coupled to tuning circuit 19 and converts the intensity of the electromagnetic wave of the specific frequency supplied from tuning circuit 19 into a digital form for a microprocessor to calculate. Calculating circuit 21 formed of the microprocessor is coupled to A/D converter 20 and receives the digitized electromagnetic wave of the specific frequency. Using the intensity of the electromagnetic wave, calculating circuit 21 calculates a position of the mobile unit, to which detector 14 is mounted, relative to marker 13.

In the seventh embodiment, a plurality of reflective markers 13 are laid down in a road along a direction in which the mobile unit is to be guided. On the other hand, marker detector 14 is mounted to the mobile unit such as a vehicle, and the mobile unit transmits/receives the electromagnetic wave to/from markers 13 with transmitting antenna 15 and receiving antenna 16. Detecting markers 13 with detector 14, the mobile unit moves. The intensity of the electromagnetic wave becomes at a peak just above marker 13, and becomes weaker along the lateral direction. Therefore, a detection of the peak can identify that the mobile unit passes over marker 13, and an intensity comparison of the received electromagnetic waves can tell a distance relative to marker 13.

Further, the reflective electromagnetic-wave marker system in accordance with the seventh embodiment has stable characteristics regardless of a structure of a place where the system is installed. The reflective markers equipped with an anti-corrosive reflective plate made from, e.g., nonferrous metal, stainless steel or aluminum, as discussed in embodiments 4-6, are used in this system. Thus the marker can be thinned, laid down in various installation environments such as a passage in a factory, various roads including an iron bridge and an overhead bridge, and used for guiding various mobile units.

The cost reduction of the reflective electromagnetic-wave marker allows a wider area to be installed with a number of the markers, or realizes shorter intervals between the markers thereby providing the mobile units with careful attention at a lower cost. The reflector formed of aluminum plate among others provides the marker with more flexible workability, so that further reduction both in cost and weight can be expected.

The reflective electromagnetic-wave marker system in accordance with the seventh embodiment, not to mention, can produce similar advantages to those of the inventions described in the first through third embodiments. To be more specific, the marker system can reduce the thickness of the marker and increase the transmitting efficiency of the transmitting antenna, and also prevent the electromagnetic-wave diffraction due to the iron bars.

Exemplary Embodiment 8

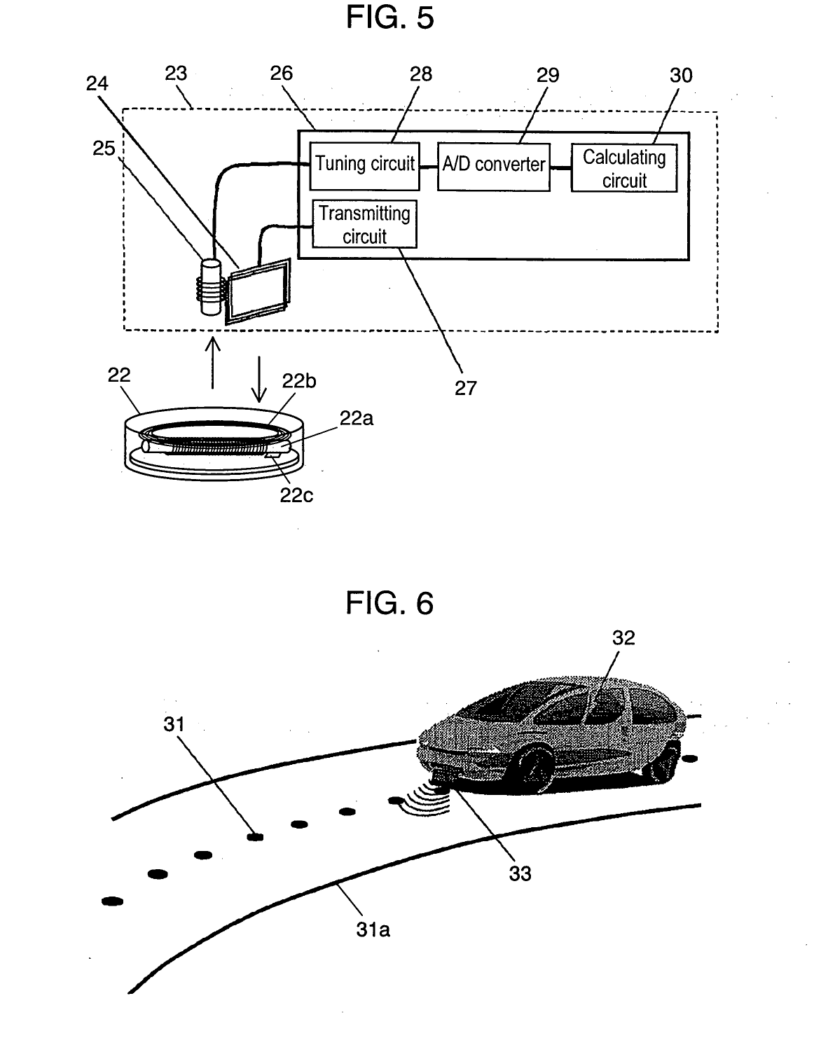

FIG. 5 shows a structure of a reflective electromagnetic-wave marker system in accordance with the eighth exemplary embodiment. Reflective electromagnetic-wave marker 22 includes receiving antenna 22a shaped like a rod and transmitting antenna 22b shaped like a disc. Antennas 22a and 22b are typically placed in parallel such that a magnetic field of a received electromagnetic-wave intersects with that of a transmitted electromagnetic wave at right angles. A frequency of the received wave is multiplied by frequency converter 22c before it is transmitted. Plural markers 22 are laid down in a road along a direction in which a mobile unit is to be guided. The marker described in any one of embodiments 3 through 6 shown in FIG. 3 is used here. Marker detector 23 is mounted to the mobile unit such as a vehicle.

Transmitting antenna 24 prepared to detector 23 transmits an electromagnetic wave of a specific frequency to reflective electromagnetic-wave marker 22. In FIG. 5, antenna 24 is formed of a flat rectangle antenna; however, it is not limited to this form. Receiving antenna 25 prepared to marker detector 23 receives the electromagnetic wave of a specific frequency reflected from reflective marker 22. In this embodiment, antenna 25 is formed of a bar antenna made by winding a coil on a ferrite bar; however, it is not limited to this form. Antennas 24, 25 are placed such that the magnetic fields of the received electromagnetic-wave and the transmitted one intersect with each other at right angles.

Detecting section 26 of marker detector 23 comprises the following elements:

transmitting circuit 27;

tuning circuit 28;

A/D converter 29; and

calculating circuit 30.

Transmitting circuit 27 is coupled to transmitting antenna 24 and outputs a specific signal to antenna 24. Tuning circuit 28 is coupled to receiving antenna 25 and tunes the received electromagnetic wave to a specific frequency for extracting the tuned frequency. A/D converter 29 is coupled to tuning circuit 28 and converts the intensity of the electromagnetic wave of the specific frequency supplied from tuning circuit 28 into a digital form for a microprocessor to calculate. Calculating circuit 30 formed of the microprocessor is coupled to A/D converter 29 and receives the digitized electromagnetic wave of the specific frequency. Using the intensity of the electromagnetic wave, calculating circuit 30 calculates a position of the mobile unit, to which detector 23 is mounted, relative to marker 22.

In the eighth embodiment, a plurality of reflective markers 22 are laid down in a road along a direction in which the mobile unit is to be guided. On the other hand, marker detector 23 is mounted to the mobile unit such as a vehicle, and the mobile unit transmits/receives the electromagnetic wave to/from markers 22 with transmitting antenna 24 and receiving antenna 25. Detecting markers 22 with marker detector 23, the mobile unit moves. The intensity of the electromagnetic wave becomes at a peak just above marker 22, and becomes weaker along the lateral direction. Therefore, a detection of the peak can identify that the mobile unit passes over marker 22, and an intensity comparison of the received electromagnetic waves can tell a relative distance to marker 22.

Antennas 22a and 22b are typically placed in parallel such that the respective magnetic fields of the electromagnetic-waves received and transmitted by marker 22 intersect with each other at right angles. Further antennas 24 and 25 are placed such that the magnetic field of electromagnetic wave transmitted from detector 23 to marker 22 and that of the one transmitted from marker 22 and received by detector 23 intersect with each other at right angles. The foregoing structure allows reducing interference between both the magnetic waves, so that the detection discussed above can be achieved more efficiently.

Further, the reflective electromagnetic-wave marker system in accordance with the eighth embodiment has stable characteristics regardless of a structure of a place where the system is installed. The reflective markers equipped with an anti-corrosive reflective plate made from, e.g., nonferrous metal, stainless steel or aluminum, as discussed in embodiments 3-6, are used in this system. Thus the marker can be thinned, laid down in various installation environments such as a passage in a factory, various roads including an iron bridge and an overhead bridge, and used for guiding various mobile units.

The cost reduction of the reflective electromagnetic-wave marker allows a wider area to be installed with a number of the markers, or realizes shorter intervals between the markers thereby providing the mobile units with careful attention at a lower cost. The reflector formed of aluminum plate among others provides the marker with more flexible workability, so that further cost reduction can be expected.

The reflective electromagnetic-wave marker system in accordance with the eighth embodiment, not to mention, can produce similar advantages to those of the inventions described in the first through third embodiments. To be more specific, the marker system can reduce the thickness of the marker and increase the transmitting efficiency of the transmitting antenna, and also prevent the electromagnetic-wave diffraction due to the iron bars.

In the eighth embodiment, transmitting antenna 24 and receiving antenna 25 prepared to marker detector 23 are placed such that the magnetic fields of both the waves intersect with each other at right angles. However, such a placement can be done only in the markers, i.e., only antennas 22a and 22b should be placed such that the magnetic fields of both received and transmitted waves intersect with each other at right angles. Although this structure produces advantages less than what discussed previously; however, this structure can adequately achieve the goal expected.

Exemplary Embodiments 9, 10

FIG. 6 shows a perspective view of an electromagnetic wave marker-system used in a mobile unit in accordance with the ninth and the tenth exemplary embodiments. The ninth embodiment refers to the invention that employs the reflective electromagnetic-wave marker system, in accordance with the seventh embodiment shown in FIG. 4, to a mobile unit such as a vehicle. The tenth embodiment refers to the invention of the multiple & reflective electromagnetic-wave marker system, in accordance with the eighth embodiment shown in FIG. 5, to a mobile unit such as a vehicle.

Reflective electromagnetic-wave marker 31 uses any one of the markers demonstrated in embodiments 1-6 shown in FIGS. 1-3. A plurality of markers 31 are laid down at appropriate intervals (hereinafter referred to as “discretely”) in road 31a along which the mobile unit is guided to a given place. A car is used as mobile unit 32 in this embodiment. Marker detector 33 uses any one of the marker detectors of the reflective electromagnetic-wave marker systems demonstrated in embodiments 7, 8 shown in FIGS. 4, 5. Mobile unit 32 includes detector 33 at its tip center and relatively closer to reflective markers 31.

In embodiments 9 and 10, mobile unit 32 detects with detector 33 the plural markers 31 discretely laid down in road 31a along the direction in which mobile unit 32 is to be guided, so that mobile unit 32 can run or stop just above reflective markers 31. In other words, the reflective electromagnetic-wave marker system can control mobile unit 32 such as guiding or stopping mobile unit 32 to or at a given place.

Embodiments 9 and 10 can make marker 31 thinner, which is the same advantage of the inventions described in embodiments 1-6. The marker is resistive to corrosion and can be laid down in various installation environments such as a passage in a factory, various roads including an iron bridge and an overhead bridge, and used for guiding various mobile units as one example is demonstrated in FIG. 6.

Further, the multiple & reflective electromagnetic wave marker system used in the tenth embodiment includes the following structure in addition to the system demonstrated in embodiment 9: The receiving antenna and the transmitting antenna of multiple & reflective electromagnetic-wave marker 31 are placed such that the respective magnetic fields of the electromagnetic-waves received/transmitted by marker 31 from/to detector 33 intersect with each other at right angles. Thus interference between both the waves can be eliminated, and a performance of detecting multiple & reflective electromagnetic-wave markers 31 can be further improved.

Further, the reflective electromagnetic-wave marker systems used in the ninth and tenth embodiments have stable characteristics regardless of a structure of a place where the system is installed. The reflective markers equipped with an anti-corrosive reflective plate made from, e.g., nonferrous metal, stainless steel or aluminum, as discussed in embodiments 4-6, are used in these systems. Thus the marker can be thinned, laid down in various installation environments such as a passage in a factory, various roads including an iron bridge and an overhead bridge, and used for guiding various mobile units.

The cost reduction of the reflective electromagnetic-wave marker allows a wider area to be installed with a number of the markers, or realizes shorter intervals between the markers thereby providing the mobile units with careful attention at a lower cost. The reflector formed of aluminum plate among others provides the reflective electromagnetic-wave marker with more flexible workability, so that further cost reduction can be expected.

The reflective electromagnetic-wave marker systems used in the ninth and tenth embodiments, not to mention, can produce similar advantages to those of the inventions described in the first through third embodiments. To be more specific, the marker system can reduce the thickness of the marker and increase the transmitting efficiency of the transmitting antenna, and also prevent the electromagnetic-wave diffraction due to the iron bars.

Exemplary Embodiments 11, 12

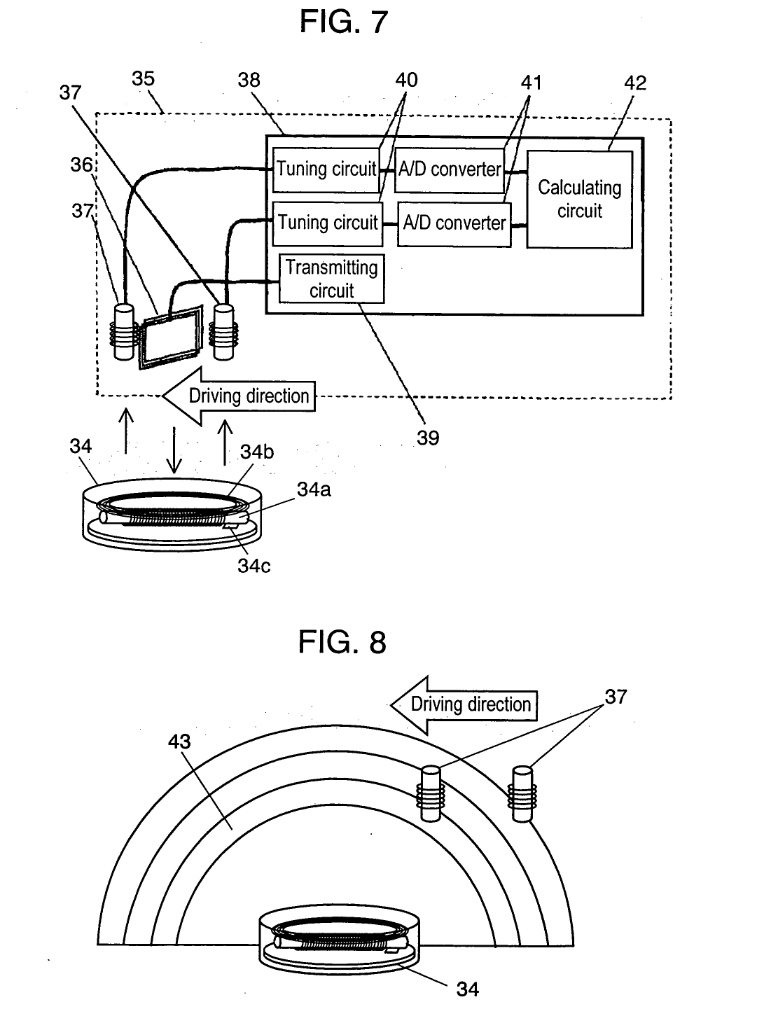

FIG. 7 shows a structure of an electromagnetic wave marker-system in accordance with the 11th and the 12th exemplary embodiments of the present invention. FIG. 8 shows a relation of a receiving antenna of a marker detector with respect to an intensity distribution image of the electromagnetic wave reflectively transmitted in the marker system. Reflective electromagnetic-wave marker 34 includes receiving antenna 34a shaped like a rod and transmitting antenna 34b shaped like a disc. Antennas 34a and 34b are typically placed in parallel such that respective magnetic fields of the received electromagnetic-wave and the transmitted electromagnetic-wave intersect with each other at right angles. A frequency of the received wave is multiplied by frequency converter 34c before it is transmitted. Plural markers 34 are laid down in a road along a direction in which a mobile unit is to be guided.

In the 11th embodiment, any one of electromagnetic-wave markers demonstrated in embodiments 1-6 shown in FIGS. 1-3 can be used, and the marker shown in FIG. 3 is used here. In the 12th embodiment, any one of electromagnetic-wave markers demonstrated in embodiments 3-6 shown in FIG. 3 can be used, and the marker shown in FIG. 3 is used here. Marker detector 35 is mounted to a mobile unit such as a vehicle.

Transmitting antenna 36 prepared to marker detector 35 transmits an electromagnetic wave of a specific frequency to reflective electromagnetic-wave marker 34. In FIG. 7, antenna 36 is formed of a flat rectangle antenna; however, it is not limited to this form. A plurality of receiving antennas (two antennas in this case) 37 prepared to marker detector 35 are typically aligned along a travelling direction of the mobile unit, and transmitting antenna 36 is placed between these two receiving antennas 37. Receiving antennas receive the electromagnetic wave of a specific frequency reflected from reflective marker 34. In this embodiment, each one of antennas 37 is formed of a bar antenna made by winding a coil on a ferrite bar; however, it is not limited to this form. Although plural antennas 37 are available, singular receiving antenna 36 is shown in FIG. 7. However, the number of receiving antenna 36 is not specified and it can be singular or plural.

Detecting section 38 of marker detector 35 comprises the following elements:

transmitting circuit 39;

two tuning circuits 40;

two A/D converters 41; and

calculating circuit 42.

Transmitting circuit 39 is coupled to transmitting antenna 36 and outputs a specific signal to antenna 36. Each one of tuning circuit 40 is coupled to each receiving antenna 37 and tunes the electromagnetic wave received by each antenna 37 to a specific frequency for extracting the tuned frequency.

Each one of A/D converters 41 is coupled to respective tuning circuits 40 and converts the intensity of the electromagnetic wave of the specific frequency supplied from tuning circuits 40 into a digital form for a microprocessor to calculate. Calculating circuit 42 formed of the microprocessor is coupled to respective A/D converters 41 and receives the digitized electromagnetic wave of the specific frequency. Using the intensity of the electromagnetic wave, calculating circuit 42 calculates a position of the mobile unit, to which detector 35 is mounted, relative to marker 34.

In other words, two receiving antennas 37 receive the electromagnetic-wave of a specific frequency from reflective electromagnetic-wave marker 34, then respective A/D converters convert the wave into a digital form. The intensities of the electromagnetic-waves of the specific frequency are compared as follows: Before the front receiving antenna 37 passes marker 34, when marker 34 is between front and rear receiving antennas 37, and after rear receiving antenna 37 passes marker 34. The relative position of the mobile unit to marker 34 is thus detected, thereby analyzing the position of the mobile unit. Reflective electromagnetic-wave marker 34 and marker detector 35 are installed to a road and a mobile unit respectively similar to reflective electromagnetic-wave marker 31 and marker detector 33 demonstrated in the ninth embodiment shown in FIG. 6.

In the 11th and 12th embodiments discussed above, the mobile unit detects with detector 35 the plural reflective markers 34 discretely laid down in a road along the direction in which the mobile unit is to be guided, so that mobile unit 32 can move. To be more specific, as receiving antenna 37 becomes closer to just above marker 34 and the height between antenna 37 and marker 34 becomes shorter, a greater receiving intensity is obtainable.

FIG. 8 shows an intensity distribution of the electromagnetic wave. Image 43 is in such a circumstance where a farther distance (lateral direction) from marker 34 (center) receives a weaker intensity of the electromagnetic wave. In this circumstance, along the driving direction of the mobile unit, front receiving antenna 37 receives an electromagnetic wave of a stronger intensity, and rear receiving antenna 37 receives the electromagnetic wave of a weaker intensity. Those intensities are compared and analyzed by calculating circuit 42 thereby detecting a relative position between the mobile unit and marker 34. The mobile unit can be thus guided or controlled its stop position.

In the 11th and 12th embodiments, two receiving antennas 37 aligned along the driving direction of the mobile unit receive the electromagnetic wave of a specific frequency transmitted from reflective marker. 34. Then respective A/D converters 41 convert the frequency into a digital form, and calculating circuit 42 compares the intensities of the wave of the specific frequency at the following three stages: (1) Before front receiving antenna 37 passes over marker 34, (2) when marker is between front receiving antenna 37 and rear receiving antenna 37, and (3) after rear receiving antenna 37 passes over marker 34. A position of the mobile unit including detector 35 relative to marker 34 can be thus detected, so that the mobile unit can be appropriately guided and controlled where the mobile unit is to stop. An elaborate comparison of the intensities with plural receiving antennas 37 will result in detecting a detailed relative position expressed in the order of “mm”.

In the 12th embodiment, reflective electromagnetic-wave marker 34 includes receiving antenna 34a that receives an electromagnetic wave transmitted from marker detector 35, and transmitting antenna 34b that transmits an electromagnetic wave of a different frequency from the received wave, of which frequency is multiplied by frequency converter 34c. Antennas 34a and 34b are placed such that the magnetic field of the received wave and that of the transmitting wave intersect with each other at right angles similar to the reflective electromagnetic-wave marker shown in FIG. 3. As a result, the marker detector can detect the marker with a weak transmitting output, and does not need to separate 1its own transmitted component from the received electromagnetic wave for detecting the marker. In other words, the electromagnetic wave is transmitted and received between marker 34 and detector 35, and the waves intersect with each other at right angles. Thus interference between both the waves can be eliminated, and a performance of detecting the position of the mobile unit relative to the reflective electromagnetic-wave marker can be further improved.

Further, the reflective electromagnetic-wave marker systems used in the 11th and 12th embodiments have stable characteristics regardless of a structure of a place where the system is installed. The reflective markers equipped with an anti-corrosive reflective plate made from, e.g., nonferrous metal, stainless steel or aluminum, as discussed in embodiments 4-6, are used in these systems. Thus the marker can be thinned, laid down in various installation environments such as a passage in a factory, various roads including an iron bridge and an overhead bridge, and used for guiding various mobile units.

The cost reduction of the reflective electromagnetic-wave marker allows a wider area to be installed with a number of the markers, or realizes shorter intervals between the markers thereby providing careful attention to the mobile units at a lower cost. The reflector formed of aluminum plate among others provides the reflective electromagnetic-wave marker with more flexible workability, so that further cost reduction can be expected.

The reflective electromagnetic-wave marker systems used in the 11th and 12th embodiments, not to mention, can produce similar advantages to those of the inventions described in the first through third embodiments. To be more specific, the marker system can reduce the thickness of the marker and increase the transmitting efficiency of the transmitting antenna, and also prevent the electromagnetic-wave diffraction due to the iron bars.

Exemplary Embodiments 13

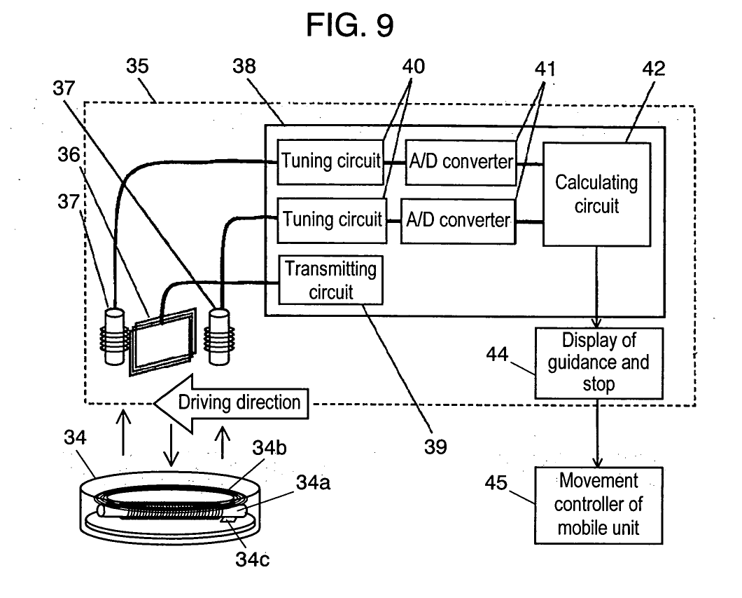

FIG. 9 shows a block diagram illustrating a structure of an electromagnetic-wave marker system in accordance with the 13th exemplary embodiment, in which any one of the electromagnetic-marker systems demonstrated in 10th-12th embodiments can be used. Here is used the marker system described in the 11th embodiment shown in FIG. 7, and means for displaying a detection result of the position of a marker detector relative to the reflective electromagnetic-wave marker is additionally disposed. Similar elements to those of 11th embodiment have the same reference marks as those in FIG. 7, and detailed descriptions thereof are omitted here. Only the differences are described hereinafter.

Display 44 formed of, e.g., a liquid crystal display, shows a guidance or a stop of a mobile unit. Display 44 is coupled to calculating circuit 42, which analyzes a relative position of the mobile unit such as a car equipped with marker detector 35 based on the detection, and receives a signal from circuit 42. This signal represents a position of the mobile unit, which includes marker detector 35, relative to marker 34. Display 44 then displays the position of the detector 35, namely, the position of the mobile unit. An operator of the mobile unit recognizes this display, so that the position is notified to the operator.

Movement controller 45 controls the driving force or braking force of the mobile unit. Controller 45 recognizes the position of the mobile unit and guides the mobile unit to a stop position, or the operator controls the driving or braking forth so that the mobile unit can stop just above marker 34 or a given position before or after marker 34 as a target position. When the mobile unit is a robot, the mobile unit controls for itself.

In the 13th embodiment, marker detector 35 mounted to the mobile unit receives/transmits the electromagnetic wave from/to marker 34 using its transmitting antenna 36 and two receiving antennas 37 during its moving, so that detector 35 detects its own position relative to marker 34.

The position detected by detector 35 is displayed on display 44, and the operator of the mobile unit recognizes the position, thereby guiding the mobile unit to a target place or stopping it at the target place with movement controller 45. When the mobile unit is a robot and can move by itself, the mobile unit can guide and stop for itself automatically.

Display 44 used in the 13th embodiment is to be installed at a place where the operator of the mobile unit including marker detector 35 or a supervisor thereof can operate movement controller 45 with his/her eyes watching display 44.

In the electromagnetic-wave marker system demonstrated in previous embodiments 7-13, the marker detector includes the transmitting antenna and the receiving antenna independently; however, actually the electromagnetic wave transmitted from the marker can be received for at least detecting a position of the detector relative to the marker. Therefore, the receiving antenna alone can achieve this object.

Industrial Applicability

The present invention relates to an electromagnetic-wave marker system and an electromagnetic-wave marker. Both of them are used for monitoring and guiding the work of machine tools or preventing danger of the machine tools. They are also used in a traffic system for unmanned vehicles or other mobile units. The marker is anti-corrosion and at the same time its thickness can be reduced, which allows the marker to be laid down in various structures of roads such as an iron bridge. The electromagnetic-wave marker system of the present invention employs this marker.

Reference Numerals in the Drawings

1, 5, 10, 22b, 34b transmitting antenna

2, 6, 11 nonmagnetic container

3, 7, 12 electromagnetic-wave reflector

1, 4, 8, 22a, 34a receiving antenna

9, 22c, 34c frequency controller

13, 22, 31, 34 reflective electromagnetic-wave marker

14, 23, 33, 35 marker detector

15, 24, 36 transmitting antenna of the marker detector

16, 25, 37 receiving antenna of the marker detector

17, 26, 38 detecting section of the marker detector

18, 27, 39 transmitting circuit

19, 28, 40 tuning circuit

20, 29, 41 A/D converter

32 mobile unit

44 display

45 movement controller

1. An electromagnetic-wave marker comprising:
a transmitting antenna for transmitting an electromagnetic wave;
a nonmagnetic container for accommodating the transmitting antenna; and
an electromagnetic wave reflector, disposed in the nonmagnetic container, for reflecting the electromagnetic wave along the transmitted direction.

2. An electromagnetic-wave marker comprising:
a receiving antenna for receiving an electromagnetic wave;
a transmitting antenna for transmitting an electromagnetic wave;
a nonmagnetic container for accommodating the receiving antenna and the transmitting antenna; and
an electromagnetic wave reflector, disposed in the nonmagnetic container, for reflecting the electromagnetic wave along the transmitting direction.

3. An electromagnetic-wave marker comprising:
a receiving antenna, shaped like a bar, for receiving an electromagnetic wave;
a frequency converting circuit, coupled to the receiving antenna, for multiplying a frequency of the electromagnetic wave;
a transmitting antenna, shaped like a disc, for transmitting an electromagnetic wave of which frequency is multiplied by the frequency converting circuit;
a nonmagnetic container for accommodating and placing the receiving antenna and the transmitting antenna such that the received electromagnetic wave and the transmitting electromagnetic wave intersect with each other at right angles; and
an electromagnetic wave reflector, disposed in the nonmagnetic container, for reflecting the electromagnetic wave along the transmitted direction.

4. The electromagnetic-wave marker of any one of claim 1 through claim 3, wherein the electromagnetic reflector is made from nonferrous metal.

5. The electromagnetic-wave marker of any one of claim 1 through claim 3, wherein the electromagnetic reflector is made from stainless steel.

6. The electromagnetic-wave marker of any one of claim 1 through claim 3, wherein the electromagnetic reflector is made from aluminum.

7. An electromagnetic-wave marker system comprising:
an electromagnetic-wave marker including:
a receiving antenna for receiving an electromagnetic wave;
a transmitting antenna for transmitting an electromagnetic wave;
a nonmagnetic container for accommodating the transmitting antenna and the receiving antenna; and
an electromagnetic wave reflector, disposed in the nonmagnetic container, for reflecting the electromagnetic wave along the transmitted direction;
another receiving antenna for receiving the electromagnetic wave transmitted from the marker; and
a marker detector for detecting an intensity of the electromagnetic wave received by the another receiving antenna.

8. An electromagnetic-wave marker system comprising:
an electromagnetic-wave marker including:
a receiving antenna, shaped like a bar, for receiving an electromagnetic wave;
a frequency converting circuit, coupled to the receiving antenna, for multiplying a frequency-of the electromagnetic wave;
a transmitting antenna, shaped like a disc, for transmitting an electromagnetic wave of which frequency is multiplied by the frequency converting circuit;
a nonmagnetic container for accommodating and placing the receiving antenna and the transmitting antenna such that the received electromagnetic wave and the transmitting electromagnetic wave intersect with each other at right angles; and
an electromagnetic wave reflector, disposed in the nonmagnetic container, for reflecting the electromagnetic wave along the transmitted direction,
another receiving antenna for receiving the electromagnetic wave transmitted from the marker; and
a marker detector for detecting an intensity of the electromagnetic wave received by the another receiving antenna.

9. An electromagnetic-wave marker system comprising:
an electromagnetic-wave marker including:
a receiving antenna for receiving an electromagnetic wave;
a transmitting antenna for transmitting an electromagnetic wave;
a nonmagnetic container for accommodating the transmitting antenna and the receiving antenna; and
an electromagnetic wave reflector, disposed in the nonmagnetic container, for reflecting the electromagnetic wave along the transmitted direction;
another receiving antenna for receiving the electromagnetic wave transmitted from the marker; and
a marker detector for detecting an intensity of the electromagnetic wave received by the another receiving antenna,
wherein a plurality of the markers are disposed discretely, and the marker detector detects the markers sequentially.

10. An electromagnetic-wave marker system comprising:
an electromagnetic-wave marker including:
a receiving antenna, shaped like a bar, for receiving an electromagnetic wave;
a frequency converting circuit, coupled to the receiving antenna, for multiplying a frequency of the electromagnetic wave;
a transmitting antenna, shaped like a disc, for transmitting an electromagnetic wave of which frequency is multiplied by the frequency converting circuit;
a nonmagnetic container for accommodating and placing the receiving antenna and the transmitting antenna such that the received electromagnetic wave and the transmitting electromagnetic wave intersect with each other at right angles; and
an electromagnetic wave reflector, disposed in the nonmagnetic container, for reflecting the electromagnetic wave along the transmitted direction,
another receiving antenna for receiving the electromagnetic wave transmitted from the marker; and
a marker detector for detecting an intensity of the electromagnetic wave received by the another receiving antenna,
wherein a plurality of the markers are disposed discretely, and the marker detector transmits/receives the electromagnetic wave to/from the markers sequentially.

11. An electromagnetic-wave marker system comprising:
an electromagnetic-wave marker including:
a receiving antenna for receiving an electromagnetic wave;
a transmitting antenna for transmitting an electromagnetic wave;
a nonmagnetic container for accommodating the transmitting antenna and the receiving antenna; and
an electromagnetic wave reflector, disposed in the nonmagnetic container, for reflecting the electromagnetic wave along the transmitted direction;
a plurality of another receiving antennas, mounted to a mobile unit along a driving direction, for receiving the electromagnetic waves transmitted from a plurality of the markers disposed discretely; and
a marker detector for comparing intensities of the respective electromagnetic waves received by the plurality of another receiving antennas.

12. An electromagnetic-wave marker system comprising:
an electromagnetic-wave marker including:
a receiving antenna, shaped like a bar, for receiving an electromagnetic wave;
a frequency converting circuit, coupled to the receiving antenna, for multiplying a frequency of the electromagnetic wave;
a transmitting antenna, shaped like a disc, for transmitting an electromagnetic wave of which frequency is multiplied by the frequency converting circuit;
a nonmagnetic container for accommodating and placing the receiving antenna and the transmitting antenna such that the received electromagnetic wave and the transmitting electromagnetic wave intersect with each other at right angles; and
an electromagnetic wave reflector, disposed in the nonmagnetic container, for reflecting the electromagnetic wave along the transmitted direction,
a plurality of another receiving antennas, mounted to a mobile unit along a driving direction, for receiving the electromagnetic waves transmitted from a plurality of the markers disposed discretely; and
a marker detector for comparing intensities of the respective electromagnetic waves received by the plurality of another receiving antennas.

13. The electromagnetic-wave marker system as defined in any one of claim 10 through claim 12, wherein the marker detector detects a position of the mobile unit with the electromagnetic waves received by the plurality of the another receiving antennas, and a recognition of the detected position of the mobile unit allows controlling a guidance and a stop position of the mobile unit.

14. The electromagnetic-wave marker system as defined in any one of claim 7 through claim 12, wherein the electromagnetic-wave reflector is made from nonferrous metal.

15. The electromagnetic-wave marker system as defined in any one of claim 7 through claim 12, wherein the electromagnetic-wave reflector is made from stainless steel.

16. The electromagnetic-wave marker system as defined in any one of claim 7 through claim 12, wherein the electromagnetic-wave reflector is made from aluminum.
